(19) United States
(12) Patent Application Publication
(10) Pub. No.: US 2013/0223395 A1
(43) Pub. Date: Aug. 29, 2013

(54) Apparatus and Method for Communication

(71) Applicants: Markus Warken, Laupheim (DE); Seppo IImari Vesterinen, Oulunsalo (FI)

(72) Inventors: Markus Warken, Laupheim (DE); Seppo IImari Vesterinen, Oulunsalo (FI)

(73) Assignee: NOKIA SIEMENS NETWORKS OY, Espoo (FI)

(21) Appl. No.: 13/883,361

(22) PCT Filed: Nov. 3, 2010
(86) PCT No.: PCT/EP10/66713

§ 371 Date: May 3, 2013

(51) Int. Cl. H04W 72/04

(52) U.S. Cl. CPC H04W 72/04
USPC 370/329

(57) ABSTRACT

Apparatus and method for communication are provided. The method includes setting up at least one second radio bearer for at least one second user equipment of the multi-radio user equipment on a second carrier, the first and second carriers being different and associating the first and at least one second radio bearers with a bearer which is set up between the apparatus and a core network. Data to be transmitted is multiplexed to the multi-radio user equipment to the first and second bearers and data received from the multi-radio user equipment on the first and second bearers is demultiplexed to the bearer which is set up between the apparatus and a core network.

### FIELD

The exemplary and non-limiting embodiments of the invention relate generally to wireless communication networks and, more particularly, to an apparatus and a method in communication networks.

### BACKGROUND

The following description of background art may include insights, discoveries, understandings or disclosures, or associations together with disclosures not known to the relevant art prior to the present invention but provided by the invention. Some of such contributions of the invention may be specifically pointed out below, whereas other such contributions of the invention will be apparent from their context.

Wireless communication systems are constantly under development. Developing systems provide a cost-effective support of high data rates and efficient resource utilization. One communication system under development is the 3rd Generation Partnership Project (3GPP) Long Term Evolution (LTE) Release 8. An improved version of the Long Term Evolution radio access system is called LTE-Advanced (LTE-A). The LTE and LTE-A are designed to support various services, such as high-speed data.

Many operators support several wireless communication systems. As the available frequency spectrum is limited, only very few operators have a large bandwidth continuous spectrum. Many operators have a fragmented spectrum; say 20 MHz in an 800 MHz band and another 20 MHz in the 2.6 GHz band, for example. Thus, the operators having a spectrum in 20 MHz wide fragments in different parts of the frequency band are currently unable to offer an extension of LTE to 40/60/80/100 MHz bandwidth for a given carrier frequency. As the maximal throughput for an LTE cell is given by the bandwidth and the MIMO (multiple-input and multiple-output) antenna configuration, the limitations in bandwidth may limit the use of some applications in the network.

### SUMMARY

The following presents a simplified summary of the invention in order to provide a basic understanding of some aspects of the invention. This summary is not an extensive overview of the invention. It is not intended to identify key/critical elements of the invention or to delineate the scope of the invention. Its sole purpose is to present some concepts of the invention in a simplified form as a prelude to a more detailed description that is presented later.

According to an aspect of the present invention, there is provided an apparatus comprising: at least one processor and at least one memory including a computer program code, the at least one memory and the computer program code configured to, with the at least one processor, cause the apparatus at least to: communicate with first user equipment of multi-radio user equipment on a first radio bearer on a first carrier, wherein the first radio bearer is associated with a bearer which is set up between the apparatus and a core network; set up at least one second radio bearer for at least one second user equipment of the multi-radio user equipment on a second carrier, the first and second carriers being different; associate the first and at least one second radio bearers with the bearer which is set up between the apparatus and a core network; multiplex data to be transmitted to the multi-radio user equipment to the first and second bearers and demultiplex data received from the multi-radio user equipment on the first and second bearers to the bearer which is set up between the apparatus and a core network.

According to another aspect of the present invention, there is provided an apparatus comprising: at least one processor and at least one memory including a computer program code, the at least one memory and the computer program code configured to, with the at least one processor, cause the apparatus at least to: communicate with a base station of a network on a first radio bearer on a first carrier using first user equipment, communicate with a base station of a network on at least one second radio bearer on at least one second carrier using at least one second user equipment, the first and second carriers being different; multiplex data to be transmitted to the base station on the first and second user equipment and demultiplex data received from the base station on the first and second bearers.

According to an aspect of the present invention, there is provided a method comprising: setting up at least one second radio bearer for at least one second user equipment of the multi-radio user equipment on a second carrier, the first and second carriers being different; associating the first and at least one second radio bearers with a bearer which is set up between the apparatus and a core network; multiplexing data to be transmitted to the multi-radio user equipment to the first and second bearers and demultiplexing data received from the multi-radio user equipment on the first and second bearers to the bearer which is set up between the apparatus and a core network.

According to an aspect of the present invention, there is provided a method comprising: communicating with a base station of a network on a first radio bearer on a first carrier using first user equipment, communicating with a base station of a network on at least one second radio bearer on at least one second carrier using at least one second user equipment, the first and second carriers being different; multiplexing data to be transmitted to the base station on the first and second user equipment and demultiplexing data received from the base station on the first and second bearers.

According to another aspect of the invention, there is provided a computer program embodied on a distribution medium, comprising program instructions which, when loaded into an electronic apparatus, control the apparatus to: communicate with first user equipment of multi-radio user equipment on a first radio bearer on a first carrier, wherein the first radio bearer is associated with a bearer which is set up between the apparatus and a core network; set up at least one second radio bearer for at least one second user equipment of the multi-radio user equipment on a second carrier, the first and second carriers being different; associate the first and at least one second radio bearers with the bearer which is set up between the apparatus and a core network; multiplex data to be transmitted to the multi-radio user equipment to the first and second bearers and demultiplex data received from the multi-radio user equipment on the first and second bearers to the bearer which is set up between the apparatus and a core network.

According to yet another aspect of the invention, there is provided a computer program embodied on a distribution medium, comprising program instructions which, when loaded into an electronic apparatus, control the apparatus to: communicate with a base station of a network on a first radio bearer on a first carrier using first user equipment, communicate with a base station of a network on at least one second radio bearer on at least one second carrier using at least one second user equipment, the first and second carriers being different; multiplex data to be transmitted to the base station on the first and second user equipment and demultiplex data received from the base station on the first and second bearers.

### LIST OF DRAWINGS

Embodiments of the present invention are described below, by way of example only, with reference to the accompanying drawings, in which

FIG. 1 shows a simplified block diagram illustrating an example of a system architecture;

FIG. 2A illustrates an example of an eNodeB;

FIG. 2B illustrates an example of user equipment;

FIG. 3 is a flow chart illustrating an embodiment; and

FIGS. 4 and 5 are signalling charts illustrating embodiments.

### DESCRIPTION OF SOME EMBODIMENTS

Exemplary embodiments of the present invention will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Although the specification may refer to “an”, “one”, or “some” embodiment(s) in several locations, this does not necessarily mean that each such reference is to the same embodiment(s), or that the feature only applies to a single embodiment. Single features of different embodiments may also be combined to provide other embodiments.

Embodiments of present invention are applicable to any network element, node, base station, server, corresponding component, and/or to any communication system or any combination of different communication systems that support required functionalities. The communication system may be a wireless communication system or a communication system utilizing both fixed networks and wireless networks. The protocols used and the specifications of communication systems, servers and user terminals, especially in wireless communication, develop rapidly. Such development may require extra changes to an embodiment. Therefore, all words and expressions should be interpreted broadly and are intended to illustrate, not to restrict, the embodiment.

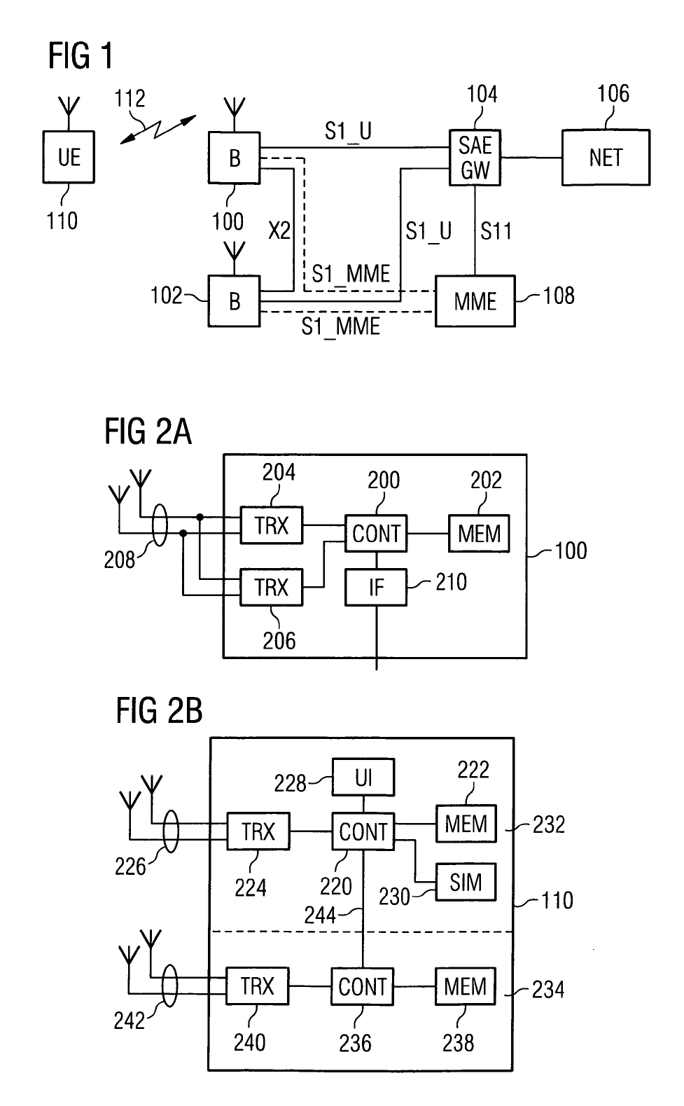

With reference to FIG. 1, let us examine an example of a radio system to which embodiments of the invention can be applied. In this example, the radio system is based on LTE network elements. However, the invention described in these examples is not limited to the LTE radio systems but can also be implemented in other radio systems.

A general architecture of a communication system is illustrated in FIG. 1. FIG. 1 is a simplified system architecture only showing some elements and functional entities, all being logical units whose implementation may differ from what is shown. The connections shown in FIG. 1 are logical connections; the actual physical connections may be different.

It is apparent to a person skilled in the art that the systems also comprise other functions and structures. It should be appreciated that the functions, structures, elements, and protocols used in or for group communication are irrelevant to the actual invention. Therefore, they need not be discussed in more detail here.

The exemplary radio system of FIG. 1 comprises a service core of an operator including the following elements: an MME

(Mobility Management Entity) 108 and an SAE GW (SAE Gateway) 104. It should be appreciated that the communication system may also comprise other core network elements besides SAE GW 104 and MME 108.

Base stations that may also be called eNodeBs (Enhanced node Bs) 100, 102 of the radio system may host the functions for Radio Resource Management: Radio Bearer Control, Radio Admission Control, Connection Mobility Control, Dynamic Resource Allocation (scheduling). The MME 108 is responsible for distributing paging messages to the eNodeBs 100, 102. The eNodeBs are connected to the SAE GW with an S1_U interface and to MME with an S1_MME interface. The eNodeBs may communicate with each other using an X2 interface. The SAE GW 104 is an entity configured to act as a gateway between the network and other parts of communication network such as the Internet 106, for example. The SAE GW may be a combination of two gateways, a serving gateway (S-GW) and a packet data network gateway (P-GW).

FIG. 1 illustrates user equipment UE 110 located in the service area of the eNodeB 100. User equipment refers to a portable computing device. Such computing devices include wireless mobile communication devices, including, but not limited to, the following types of devices: mobile phone, smartphone, personal digital assistant (PDA), handset, laptop computer. The apparatus may be battery powered.

In the example situation of FIG. 1, the user equipment 110 has a connection 112 with the eNodeB 100. The connection 112 may be a bidirectional connection related to a speech call or a data service such as browsing the Internet 110.

FIG. 1 only illustrates a simplified example. In practice, the network may include more base stations and more cells may be formed by the base stations. The networks of two or more operators may overlap, the sizes and form of the cells may vary from what is depicted in FIG. 1, etc.

The embodiments are not restricted to the network given above as an example, but a person skilled in the art may apply the solution to other communication networks provided with the necessary properties. For example, the connections between different network elements may be realized with Internet Protocol (IP) connections.

FIG. 2A illustrates an example of an eNodeB. The eNodeB 100 comprises a controller 200 operationally connected to a memory 202. The controller 200 controls the operation of the base station. The memory 202 is configured to store software and data. The eNodeB comprises a first transceiver 204 is configured to set up and maintain a wireless connection to user equipment within the service area of the base station on a given first carrier. In this example, the eNodeB comprises a second transceiver 206 is configured to set up and maintain a wireless connection to user equipment on a given second carrier, the first and second carrier frequencies being different. The transceivers 204, 206 are operationally connected the controller 200 and to an antenna arrangement 208. The antenna arrangement may comprise a set of antennas. The number of antennas may be two to four, for example. The number of antennas is not limited to any particular number.

The base station may be operationally connected to other network elements of the communication system. The network element may be an MME (Mobility Management Entity), an SAE GW (SAE Gateway), a radio network controller (RNC), another base station, a gateway, or a server, for example. The base station may be connected to more than one network element. The base station 100 may comprise an interface 210 configured to set up and maintain connections with the network elements.

In an embodiment, the first and second transceivers operate in the same communication network, such as LTE, for example. In addition, the transceivers may operate in different coexisting networks or communication techniques such as UMTS (Universal Mobile Telecommunications System), GSM/GPRS (Global System for Mobile Communications/ General packet radio service), or HSPA (High-Speed Packet Access). The number of transceiver sis not limited to two, as one skilled in the art is aware.

FIG. 2B illustrates examples of user equipment 110. The user equipment 110 comprises a controller 220 operationally connected to a memory 222 and a transceiver 224. The controller 220 controls the operation of the user equipment. The memory 222 is configured to store software and data. The transceiver 224 is configured to set up and maintain a wireless connection to an eNodeB on a given first carrier. The transceiver 224 is operationally connected to an antenna arrangement 226. The antenna arrangement may comprise a set of antennas. The number of antennas may be one to four, for example. As with the eNodeB, the number of antennas is not limited to any particular number.

The user equipment 110 further comprises user interface 228. The user interface may comprise a speaker, a keyboard, a display, a microphone and a camera, for example. The user equipment 110 may further comprise a subscriber identity module (SIM) 230 on a removable SIM card, for example. The SIM stores the service-subscriber key, such as an International Mobile Subscriber Identity (IMSI) which is used to identify a subscriber on communication networks.

In an embodiment, the user equipment 110 is multi-radio user equipment. The above mentioned parts of the user equipment 110 form first or primary user equipment 232. In addition, the user equipment 110 may comprise second or secondary user equipment 234. The second user equipment comprises a controller 236 operationally connected to a memory 238 and a transceiver 240. The controller 236 controls the operation of the second user equipment. The memory 238 is configured to store software and data. The transceiver 240 is configured to set up and maintain a wireless connection to an eNodeB on a given second carrier. The transceiver 240 is operationally connected to an antenna arrangement 242. In an embodiment, the first and second user equipment may share a common antenna arrangement.

In an embodiment, the first and second user equipment operates in the same communication network, such as LTE, for example. In addition, the user equipment may operate in different co-existing networks or communication techniques such as UMTS (Universal Mobile Telecommunications System), GSM/GPRS (Global System for Mobile Communications/ General packet radio service), or HSPA (High-Speed Packet Access).

In an embodiment, the controller 200 of the first user equipment controls the controller 236 of the second user equipment via Application Interface (API) 244, where the controller 200 of the first user equipment is a master and the controller 236 of the second user equipment is a slave.

The number of user equipment is not limited to two as in the example of FIG. 2B.

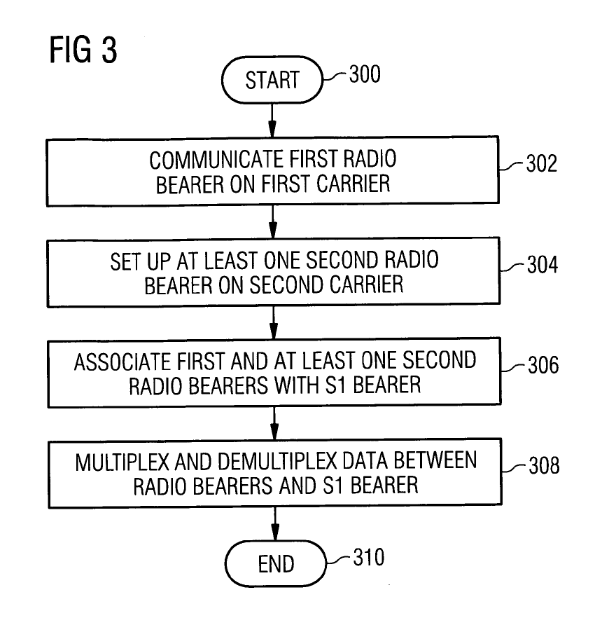

FIG. 3 is a flow chart illustrating an embodiment. The embodiment starts at step 300.

In step 302, the eNodeB 100 communicates with the user equipment 110 on a first radio bearer on a first carrier. The user equipment 110 is multi-radio user equipment. In an embodiment, the communication is realized between the first user equipment 232 of the user equipment 110 and the transceiver 204 of the eNodeB. The first radio bearer is associated with a S1 bearer which is set up between the eNodeB and a core network over the S1_U interface. In an embodiment, the S1_bearer and the first radio bearer form an EPS (Evolved Packet System) bearer which may be considered as a logical connection between the user equipment 110 and the core network.

In step 304, a second radio bearer is set up for at the second user equipment 234 of the user equipment 110 on a second carrier, the first and second carriers being different.

In step 306, the first and at least one second radio bearers associated with the S1 bearer. Thus, from the core network point of view, only one EPS bearer exists.

In step 308, data between the radio bearers and the S1 bearer is multiplexed and demultiplexed.

In step 310, the process ends.

In an embodiment, the carrier aggregation feature can be implemented in the user equipment that have simultaneous dual carrier capability either by using an integrated radio for a second carrier or by using a separate modem device connected to the first user equipment with a proper local data interface, such as USB (Universal Serial Bus), Bluetooth™, for example, and Application Protocol Interface (API) for control and user data traffic transfers.

In an embodiment, the aggregated data bearer service can be established when both the user equipment and the serving eNodeB support dual carriers on different frequencies.

In an embodiment, aggregation of several carriers may be realized in multi-radio user equipment by coupling second user equipment to the same User Identity (IMSI) and Mobile Station ID (MSISDN), and defining a new enhanced UE Network Capability Information Element to support a secondary and simultaneous carrier on demand.

In this way, the implementation of an aggregated bearer service can be considered as one EPS Bearer for a single user from the core network point of view.

The eNodeBs having multiple transceivers may be configured to have at least one cell on different carrier frequency than the other(s). These cells belong to the same TA (Tracking Area). In addition, a new Packet Data Convergence Protocol PDCP functionality may be established in order to support user equipment with carrier aggregated data bearer services. The new PDCP functionality takes care of the data multiplexing and demultiplexing functions for lower layer data paths at PDCP layer and below. The functionality may be called “Super PDCP”.

User equipment with simultaneous multiple carrier capability may configure one carrier as a primary carrier for signalling to the network and for the default data bearer service. The user equipment may keep the secondary carrier in the idle state (RRC_IDLE) on default and activate the second transceiver for its secondary carrier only on demand i.e. when some application layer service needs increased bandwidth.

In an embodiment, the overall management for simultaneous multi-carrier capability is implemented in the user equipment, the core network and the eNodeB as follows: User equipment that has simultaneous multi-carrier capability may be configured to indicate this to the network when performing initial registering to a network. The network is configured to store the information regarding the capability to UE Context data which is stored in the MME 108.

The eNodeB serving the user equipment may receive the capability information in an Initial Context Setup Request message from the MME during Initial Attach or UE Triggered Service Request (Idle to Active state movements) procedures. The eNodeB includes the capability information into the UE eNodeB context data. When or if the user equipment performs a handover this context data is transferred also from eNodeB to another, while user equipment is in active mode.

The user equipment 110 may be configured to use the first user equipment 232 as primary user equipment. The eNodeB may issue to the primary user equipment its capability to support or not a secondary carrier and when supported issue also the identifiers of the other carrier and radio parameters.

In an embodiment, when information regarding the capability of the user equipment has been received in the network and a default EPS bearer has been established between the network and the multi-carrier user equipment the MME may configure the corresponding E-RAB bearer (Evolved Radio Access Bearer) parameters taking the increased user equipment capabilities into account

The eNodeB that has received from the EPC the user equipment capability information for simultaneous multi-carrier capability and that has at least transceiver able to communicate on different carrier frequency than the other(s) (i.e has at least one cell on different carrier frequency than the others) may configure the primary E-RAB bearer path as usual and prepare to configure the secondary E-RAB bearer path on demand.

In an embodiment, the eNodeB with multi-carrier capability may command the primary user equipment of a multi-carrier user equipment to measure its secondary cell on different frequency. The primary user equipment may delegate the interfrequency measurements to its secondary user equipment but it is configured to combine the measurement reports to be signalled over the primary (Radio Resource Control) RRC signalling connection to its serving eNodeB.

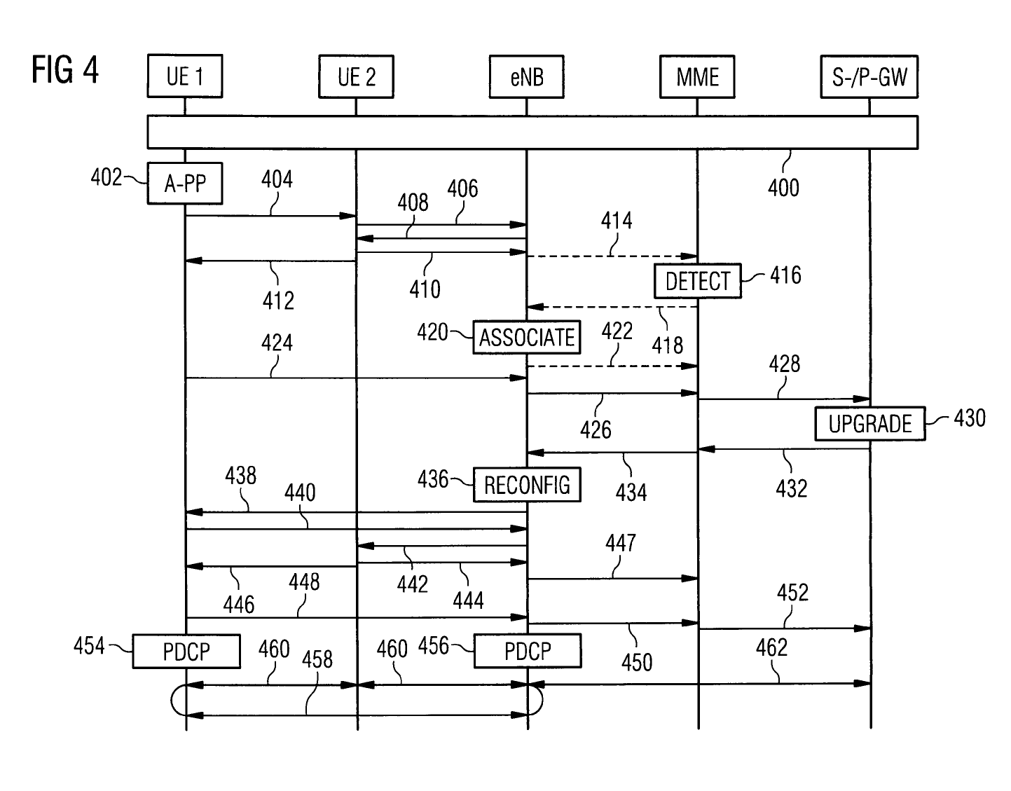

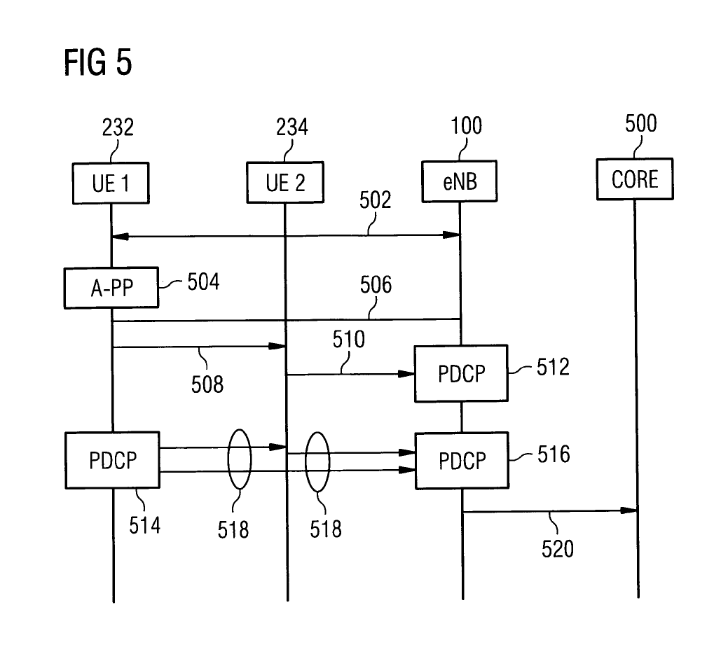

FIG. 4 is a signalling chart illustrating an embodiment. The chart illustrates an example of signalling messages between the eNodeB 100, the MME 108 and SAE-GW 104 and the user equipment 110 comprising first and second user equipment 232, 234.

In the beginning, a default EPS bearer has been established 400 between the network and the first user equipment 232 of the multi-radio user equipment 110.

Let us assume that the user of the user equipment 110 initiates 402 an application layer service that needs more bandwidth than what the default EPS bearer can offer.

The first user equipment 232 is configured to request 404 the second user equipment 234 to select a cell of the eNodeB utilising a different carrier than the one the first user equipment is using and to establish an RRC connection via the cell to the serving eNodeB. The first user equipment shall generate the upper layer parameters for the connection request messages of the second user equipment. Examples of the parameters are UE-identity, establishmentCause, selectedPLMNIdentity, registeredMME and dedicatedInfoNAS) which are to be transported over the second RRC signalling connection.

The second user equipment may reject request of the first user equipment in case the measured radio link quality on cell a cell of the eNodeB utilising a different carrier is poor.

On the basis of the request of the first user equipment, the second user equipment sends a RRCConnectionRequest message 406 to the eNodeB which responds with RRCConnection Setup message 408. Finally, the second user equipment transmits RRCConnection SetupComplete 410 message to the eNodeB. The second user equipment transmits information 412 to the first user equipment that it has moved into an RRC connection state.

As the eNodeB 100 stores only a temporary UE identifier in the UE eNB context data, it cannot resolve on basis of the received UE-identity that the new RRC connection over the different carrier is associated to the user equipment using the primary RRC-connection.

In an embodiment, this is solved by enhancing the RRC protocol to carry a unique E-UTRAN level UE Identity that will be stored in the first user equipment and eNodeB UE context data. Now the eNodeB 100 may associate the new RRC connection setup procedure to the existing eNodeB UE Context. The eNodeB is able to route MMS related information received from the second user equipment to MME 108 using the already existing UE dedicated S1AP signalling connection.

In another embodiment, the eNodeB creates a new temporary UE dedicated S1AP signalling connection to MME 108 for transfer 414 Initial UE Message comprising MMS related information received from the second user equipment. The MME 108 detects 416 that the issued UE Identity matches with the already existing S1AP signalling connection of the first user equipment (which may be assumed to be in Active mode). The MME may respond to the eNodeB with an enhanced UE Context Modification Request message 418 over the S1AP signalling connection for the first user equipment by including a new information element for the temporary eNB UE S1AP ID. Now the eNodeB can associate 420 the two RRC connections belonging to the same multi-carrier user equipment in continuation. Finally, the eNodeB may send an acknowledgement 422 to the MMS. This embodiment has the advantage over the previous one in that the RRC connection procedure needs not to be changed.

When the second user equipment 234 has indicated 412 to the first user equipment 232 that it has moved to RRC-Connected state the secondary E-RAB bearer setup can be initiated either by the first user equipment 232 or eNodeB 100. In an embodiment, the first user equipment initiated secondary E-RAB bearer setup can be handled by using a user equipment requested bearer resource modification procedure as follows: The first user equipment issues a NonAccessStratum (NAS) message 424, 426 via eNodeB 100 to MME 108 requesting bearer resource modification with the desired Quality of Service (QoS) parameters. The parameters define the larger bandwidth provided by the second radio bearer and which is to be added to the existing bearer of the first user equipment.

The MME 108 queries 428 the Gateway 104 for capacity for the larger bandwidth. The Gateway 104 upgrades 430 the QoS of the EPS bearer and the existing E-RAB bearer of the user equipment 110 as requested. Information of the upgrade is sent 432 to the MME which forwards the information to the eNodeB as an E-RAB Modify Request message 434.

The eNodeB 100 shall decide 436 establishment of a secondary E-RAB based on the received E-RAB QoS parameters and availability of the secondary channel (which is associated with the second user equipment in the RRC-Connected state).

The eNodeB 100 is configured to execute RRCConnectionReconfiguration procedure 438, 440 with proper radio bearer parameters in order to complete the UE requested bearer resource modification procedure. As a secondary E-RAB setup is needed the eNodeB 100 executes in parallel another RRCConnectionReconfiguration procedure 442, 444 to the second user equipment with the proper radio bearer parameters. The eNodeB 100 is configured to acknowledge the E-RAB Modify Request message sent by the MMS by sending a E-RAB Modify Response message 447 to the MMS.

The second user equipment 234 sends the first user equipment a message 446 with the information it has established radio data bearer service and QoS designated to the bearer service. On the basis of the message the first user equipment may send the core network via the eNodeB 100 a Session Management Response 448, 450, 452 which indicated the corer network that he bearer resource modification has been completed.

In addition, on the basis of the message the first user equipment is configured to configure 454 a multiplexer/demultiplexer functionality in upper layer PDCP function. The PDCP functionality takes care of the data multiplexing and demultiplexing functions for lower layer data paths at PDCP layer and below. Thus, the first user equipment is capable of multiplexing and demultiplexing the data communicated using the radio bearers of the first and second user equipment.

In a similar manner, the eNodeB 100 configures 456 the multiplexer/de-multiplexer functionality in its upper layer PDCP function correspondingly when the both E-RAB configurations are completed.

From now on the simultaneous user IP traffic transfer over aggregated carriers can be started. The PDCP functionality in the user equipment 110 divides the uplink traffic between the first user equipment bearer 458 and the second user equipment bearer 460. The eNodeB 100 multiplexes and demultiplexes the data between the radio bearers 258, 460 and the S1 bearer 462.

In an embodiment when an Inter eNodeB handover occurs, the source eNodeB is configured to transfer the UE eNB context data with the current E-RAB settings to the target eNodeB in a Handover Request message.

The target eNodeB may be configured to respond with a Handover Request Ack message that indicates to the source eNodeB whether it can proceed with handover and support continuation of the issued E-RAB bearer services.

In case the possible second E-RAB for carrier aggregation can be supported in the target eNodeB, it should respond with an enhanced Handover Request Ack message containing the target cell Id and parameters for the second carrier in order to perform simultaneous handover on the both carriers.

In case the target eNodeB cannot support the second connection the source eNodeB may be configured to issue an RRCConnectionRelease message to the second user equipment instead of a HandoverCommand message. Thus, the second bearer connection is terminated.

In an embodiment, a core network proxy function is implemented in the serving eNodeB for the second user equipment in order to setup a second data bearer service for carrier aggregation on demand and transparently to the core network. The flowchart of FIG. 5 illustrates this embodiment. The chart illustrates an example of signalling messages between the eNodeB 100, the core network 500 (comprising MME and SAE-GW) and the first and second user equipment 232, 234. In this embodiment, the both user equipment may comprise a subscriber identity module (SIM).

First, a connection setup 502 between the eNodeB 100 and the first user equipment on a first carrier is performed. This follows the standard procedure. Thus, a default EPS bearer has been established.

Let us assume that the user of the first user equipment initiates 504 an application layer service that needs more bandwidth than what the default EPS bearer can offer either by limitations or by congestion.

The first user equipment requests for a QoS for this connection that is not possible in the carrier selected for the first user equipment.

Next, the super PDCP functionality in the first user equipment informs 506 the super PDCP functionality in the eNodeB that it is about to set up a secondary connection through a second carrier by using the second user equipment. In an embodiment, is the MSISDN of the second user equipment is signalled to the super PDCP functionality in the eNodeB, then to make a data base inquiry in the network for the IMSI of the second user equipment and to use this information for the following.

The first user equipment triggers 508 the second user equipment to set up 510 a connection on another carrier, i.e. it uses the second user equipment as modem. The signalling of this connection is terminated in the super PDCP functionality of the eNodeB 100, i.e. this function serves as network proxy towards the second user equipment. The super PDCP functionality 512 sets up the RRC connection for the second user equipment, informs the core network of the resource usage and acknowledges the connection set up to the second user equipment.

During the following data transfer 518, 520, the super PDCP layers 514, 516 distribute the traffic between the carrier used by the first and second user equipment. Everything there from PDCP layer downwards is standard LTE communication. The super PDCP layer functionalities act towards the upper layers and towards GTP-u (GPRS Tunneling Protocol, User Plane) as PDCP layer. Thus, the second carrier is transparent beyond the super PDCP layer functionalities.

In an embodiment, a handover is implemented by disconnecting the second connection briefly, perform a standard handover procedure, and then re-connect the connection of the second user equipment, if the target eNodeB supports the feature.

An embodiment provides an apparatus comprising: means for communicate with first user equipment of multi-radio user equipment on a first radio bearer on a first carrier, wherein the first radio bearer is associated with a bearer which is set up between the apparatus and a core network; means for setting up at least one second radio bearer for at least one second user equipment of the multi-radio user equipment on a second carrier, the first and second carriers being different; means for associating the first and at least one second radio bearers with the bearer which is set up between the apparatus and a core network; means for multiplexing data to be transmitted to the multi-radio user equipment to the first and second bearers and means for demultiplexing data received from the multi-radio user equipment on the first and second bearers to the bearer which is set up between the apparatus and a core network.

An embodiment provides an apparatus comprising: means for communicating with a base station of a network on a first radio bearer on a first carrier using first user equipment, communicating with a base station of a network on at least one second radio bearer on at least one second carrier using at least one second user equipment, the first and second carriers being different; means for multiplexing data to be transmitted to the base station on the first and second user equipment and means for demultiplexing data received from the base station on the first and second bearers.

The steps, signalling messages and related functions described above and in the attached figures are in no absolute chronological order, and some of the steps may be performed simultaneously or in an order differing from the given one. Other functions can also be executed between the steps or within the steps. Some of the steps can also be left out or replaced with a corresponding step.

The apparatuses or controllers able to perform the above-described steps may be implemented as an electronic digital computer, which may comprise a working memory (RAM), a central processing unit (CPU), and a system clock. The CPU may comprise a set of registers, an arithmetic logic unit, and a controller. The controller is controlled by a sequence of program instructions transferred to the CPU from the RAM. The controller may contain a number of microinstructions for basic operations. The implementation of microinstructions may vary depending on the CPU design. The program instructions may be coded by a programming language, which may be a high-level programming language, such as C, Java, etc., or a low-level programming language, such as a machine language, or an assembler. The electronic digital computer may also have an operating system, which may provide system services to a computer program written with the program instructions.

An embodiment provides a computer program embodied on a distribution medium, comprising program instructions which, when loaded into an electronic apparatus, are configured to control the apparatus to execute the embodiments described above.

The computer program may be in source code form, object code form, or in some intermediate form, and it may be stored in some sort of carrier, which may be any entity or device capable of carrying the program. Such carriers include a record medium, computer memory, read-only memory, and a software distribution package, for example. Depending on the processing power needed, the computer program may be executed in a single electronic digital computer or it may be distributed amongst a number of computers.

The apparatus may also be implemented as one or more integrated circuits, such as application-specific integrated circuits ASIC. Other hardware embodiments are also feasible, such as a circuit built of separate logic components. A hybrid of these different implementations is also feasible. When selecting the method of implementation, a person skilled in the art will consider the requirements set for the size and power consumption of the apparatus, the necessary processing capacity, production costs, and production volumes, for example.

It will be obvious to a person skilled in the art that, as technology advances, the inventive concept can be implemented in various ways. The invention and its embodiments are not limited to the examples described above but may vary within the scope of the claims.

1. An apparatus comprising:
at least one processor and at least one memory including a computer program code, the at least one memory and the computer program code configured to, with the at least one processor, cause the apparatus at least to:
communicate with first user equipment of multi-radio user equipment on a first radio bearer on a first carrier, wherein the first radio bearer is associated with a bearer which is set up between the apparatus and a core network;
set up at least one second radio bearer for at least one second user equipment of the multi-radio user equipment on a second carrier, the first and second carriers being different;
associate the first and at least one second radio bearers with the bearer which is set up between the apparatus and a core network;
multiplex data to be transmitted to the multi-radio user equipment to the first and second bearers and
demultiplex data received from the multi-radio user equipment on the first and second bearers to the bearer which is set up between the apparatus and a core network.

2. The apparatus of claim 1, the apparatus being configured to multiplex and demultiplex user equipment data above Packet Data Convergence Protocol layer.

3. The apparatus of claim 1, the apparatus being configured to receive from second user equipment a request to set up a second radio bearer on a second carrier, the request comprising the identity of a multi-radio user equipment;
detect that a first radio bearer on a first carrier is allocated to the first user equipment having the same identity, and
associate the first and second radio bearers to the same identity.

4. The apparatus of claim 3, wherein the request sent by the second user equipment comprises information that the connection to be set up is to be associated with the connection of the first user equipment.

5. (canceled)

6. (canceled)

7. (canceled)

8. The apparatus of claim 1, wherein the apparatus is configured to
act as a core network proxy for the at least one second user equipment;
communicate with first user equipment of multi-radio user equipment on a first radio bearer on a first carrier, wherein the first radio bearer is associated with a bearer which is set up between the apparatus and a core network;
receive information from the first user equipment on a need to set up a connection with a second user equipment of multi-radio user equipment on the second carrier, the information comprising the MSIDSN of the second user equipment;
retrieve the IMSI of the second user equipment from core network;
receive a connection set up request from the second user equipment; and
set up the connection with the second user equipment on the second carrier.

9. The apparatus of claim 1, wherein apparatus is configured to communicate with the first and second user equipment of the multi-radio user equipment using different radio technologies.

10. An apparatus comprising:
at least one processor and at least one memory including a computer program code, the at least one memory and the computer program code configured to, with the at least one processor, cause the apparatus at least to:
communicate with a base station of a network on a first radio bearer on a first carrier using first user equipment, communicate with a base station of a network on at least one second radio bearer on at least one second carrier using at least one second user equipment, the first and second carriers being different;
multiplex data to be transmitted to the base station on the first and second user equipment and
demultiplex data received from the base station on the first and second bearers.

11. The apparatus of claim 10, wherein apparatus is configured to
communicate with a base station of a network on a first radio bearer on a first carrier using first user equipment;
detect a need for larger bandwidth;
request the base station to set up a second radio bearer on a second carrier, the request comprising the identity of the apparatus.

12. The apparatus of claim 11, wherein apparatus is configured to
receive information that the second radio bearer has been set up;
send a bearer modification message to the network;
receive information regarding bearer modification; and set up multiplexing and demultiplexing of the first and second radio bearer.

13. (canceled)

14. A method comprising:
setting up at least one second radio bearer for at least one second user equipment of the multi-radio user equipment on a second carrier, the first and second carriers being different;
associating the first and at least one second radio bearers with a bearer which is set up between the apparatus and a core network;
multiplexing data to be transmitted to the multi-radio user equipment to the first and second bearers and
demultiplexing data received from the multi-radio user equipment on the first and second bearers to the bearer which is set up between the apparatus and a core network.

15. The method of claim 14, further comprising:
multiplexing and demultiplexing user equipment data above Packet Data Convergence Protocol layer.

16. The method of claim 14, further comprising:
receiving from second user equipment a request to set up a second radio bearer on a second carrier, the request comprising the identity of a multi-radio user equipment;
detecting that a first radio bearer on a first carrier is allocated to the first user equipment having the same identity, and
associating the first and second radio bearers to the same identity.

17. The method of claim 16, wherein the request sent by the second user equipment comprises information that the connection to be set up is to be associated with the connection of the first user equipment.

18. (canceled)

19. (canceled)

20. (canceled)

21. The method of claim 14, further comprising:
acting as a core network proxy for the at least one second user equipment;
communicating with first user equipment of multi-radio user equipment on a first radio bearer on a first carrier, wherein the first radio bearer is associated with a bearer which is set up between the apparatus and a core network;
receiving information from the first user equipment on a need to set up a connection with a second user equipment of multi-radio user equipment on the second carrier, the information comprising the MSIDSN of the second user equipment;
retrieving the IMSI of the second user equipment from core network;
receiving a connection set up request from the second user equipment; and
setting up the connection with the second user equipment on the second carrier.

22. The method of claim 14, further comprising: communicating with the first and second user equipment of the multi-radio user equipment using different radio technologies.

23. A method comprising:
communicating with a base station of a network on a first radio bearer on a first carrier using first user equipment, communicating with a base station of a network on at least one second radio bearer on at least one second carrier using at least one second user equipment, the first and second carriers being different;
multiplexing data to be transmitted to the base station on the first and second user equipment and
demultiplexing data received from the base station on the first and second bearers.

24. The method of claim 23, further comprising:
communicating with a base station of a network on a first radio bearer on a first carrier using first user equipment; detecting a need for larger bandwidth;
requesting the base station to set up a second radio bearer on a second carrier, the request comprising the identity of the apparatus.

25. The method of claim 23, further comprising:
receiving information that the second radio bearer has been set up;
sending a bearer modification message to the network;
receiving information regarding bearer modification; and setting up multiplexing and demultiplexing of the first and second radio bearer.

26. (canceled)

27. (canceled)

28. (canceled)

29. The apparatus of claim 1, wherein the apparatus comprises a base station.

30. The apparatus of claim 10, wherein the apparatus comprises a user equipment.
